(19) United States
(12) Patent Application Publication
(10) Pub. No.: US 2022/0408965 A1
(43) Pub. Date: Dec. 29, 2022

(54) CHEESECAKE PAN BRACKET FOR WATER BATH

(71) Applicant: Scott Voichoskie, Fullerton, NE (US)

(72) Inventor: Scott Voichoskie, Fullerton, NE (US)

(21) Appl. No.: 17/835,537

(22) Filed: Jun. 8, 2022

Related U.S. Application Data
(60) Provisional application No. 63/216,273, filed on Jun. 29, 2021.

(51) Int. Cl. A47J 37/01; A47J 27/10; A21B 3/13

(52) U.S. Cl. CPC A47J 37/01; A47J 27/10; A21B 3/13

(57) ABSTRACT

A system and method for cooking food products in a water bath are disclosed. Such a system may include a bracket comprised of one or more member spans mated with a fastener or adhesive. The one or more member spans may be comprised of one or more: members or adjustable member spans; first raised portions; second raised portions; first coupling structures; second coupling structures; and water level markings. Such a method may include filling a first pan with a food product; securing a bracket formed from two or more of a plurality of members onto a second pan; filling the second pan with water; placing the first pan onto the bracket; and baking the food product.

### CROSS-REFERENCE TO RELATED APPLICATION

The present application claims the benefit under 35 U.S.C. § 119(e) of U.S. Provisional Application Ser. No. 63/216,273 entitled “CHEESECAKE PAN BRACKET FOR WATER BATH” filed on Jun. 29, 2021, which is incorporated herein by reference in the entirety.

### TECHNICAL FIELD

The present invention generally relates to the baking of food products using a water bath. In particular, the invention relates to the baking of cheesecakes.

### INTRODUCTION

Cheesecakes are desserts containing cheese, eggs, and sugar that are traditionally baked with a water bath, or bain-marie. The water bath controls the heating of the cheesecake and cheesecake pan, and prevents cracking of the surface of the cheesecake. Baking a cheesecake with a water bath requires skill as tilting and/or shaking of the water bath and cheesecake batter during transfer to the oven may cause water to escape the water bath and contaminate or ruin the cheesecake batter. “Moated” cakepans may be used that have a center baking pan section surrounded by a moat that can be filled with water. However, these cakepans constrain the size and/or shape of the cheesecake, and some moated cakepans do not expose the bottom of the center baking section to water, limiting their effectiveness.

Therefore, it would be advantageous to provide a system and method that overcomes the shortcomings described above.

### SUMMARY

A bracket system is disclosed, in accordance with one or more embodiments of the present disclosure. In one illustrative embodiment, the system may include but is not limited to a first pan mounted inside a second pan by means of a bracket. In another illustrative embodiment, the second pan is configured to be filled to a certain level with water and the first pan is configured to be filled with a food product. In another illustrative embodiment, when the first pan and the second pan are baked together, the food product in the first pan receives the culinary benefits of a water bath. In another illustrative embodiment, the bracket is comprised of a plurality of members coupled to one another with a connector. In another illustrative embodiment, a member span spans the length of each of the two or more members. In another illustrative embodiment, the member span is adjustable in length due to the presence of adjustable member spans. In another illustrative embodiment, each member span comprises a first raised portion on one end and a second raised portion on the other, with a water level marking on at least one of the first raised portion or second raised portion. In another illustrative embodiment, a first coupling structure and a second coupling structure are attached to the first raised portion and the second raised portion, respectively. In another illustrative embodiment, the first coupling structure and the second coupling structure couple the bracket to the second pan and allow the first pan to be supported when baking a food product requiring a water bath.

A water bath cooking method is disclosed, in accordance with one or more embodiments of the present disclosure. In one illustrative embodiment, the method may include, but is not limited to, filling a first pan with a food product. In another illustrative embodiment, the method may include securing a bracket formed from two or more of a plurality of members onto a second pan. In another illustrative embodiment, the method may include filling the second pan with water. In another illustrative embodiment, the method may include placing the first pan onto the bracket. In another illustrative embodiment, the method may include baking the food product.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures in which:

FIG. 1A illustrates a perspective view of the system for baking, in accordance with one or more embodiments of the disclosure;

FIG. 1B illustrates a perspective view of the system with the first pan removed, in accordance with one or more embodiments of the disclosure;

FIG. 1C illustrates a plan view of the system, in accordance with one or more embodiments of the disclosure;

FIG. 1D illustrates a perspective view of the bracket, in accordance with one or more embodiments of the disclosure;

FIG. 1E is a perspective view of the bracket, in accordance with one or more embodiments of the disclosure;

FIG. 2A illustrates a side view of a portion of a member having an adjustable member span, in accordance with one or more embodiments of the disclosure;

FIG. 2B illustrates a plan view of the system having an adjustable member span, in accordance with one or more embodiments of the disclosure;

FIG. 3 illustrates a partial view of a member, in accordance with one or more embodiments of the disclosure;

FIG. 4 is a flow chart illustrating a method for baking a food product via the bracket, in accordance with one or more embodiments of the disclosure; and

FIG. 5 illustrates a perspective view of the bracket, in accordance with one or more embodiments of the disclosure.

### DETAILED DESCRIPTION OF THE INVENTION

Reference will now be made in detail to the subject matter disclosed, which is illustrated in the accompanying drawings.

Embodiments of the present disclosure are directed to a bracket for use in the baking of cheesecakes. The bracket is created from individual members that, when coupled and placed on a water bath, create a surface that can suspend a cheesecake pan, allowing a portion of the cheesecake pan to be immersed in the water bath.

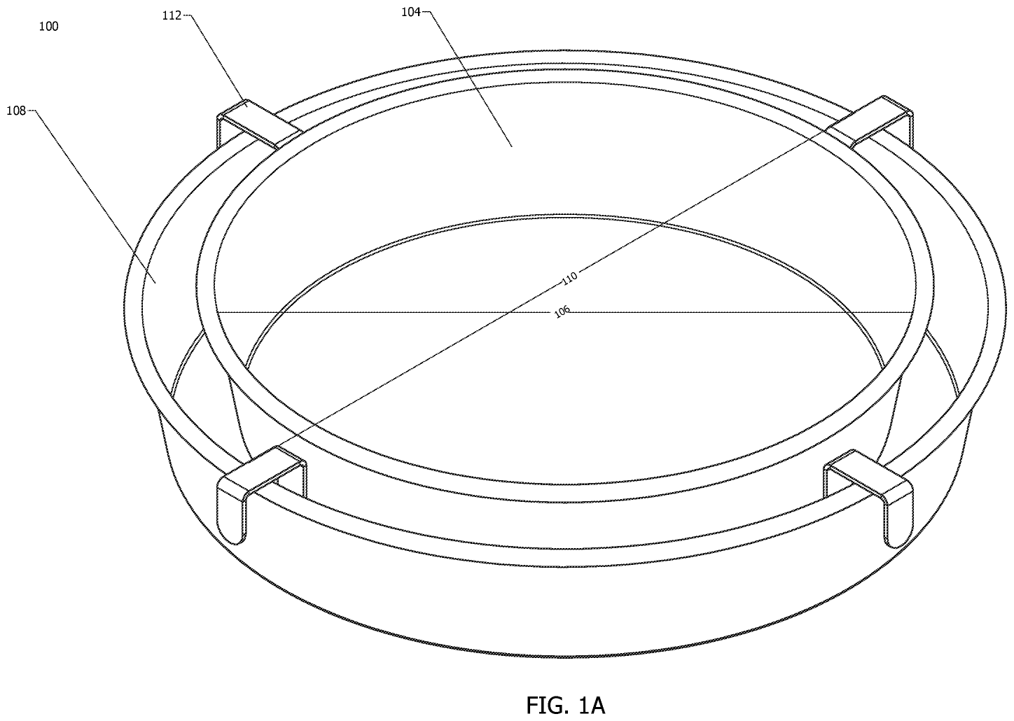

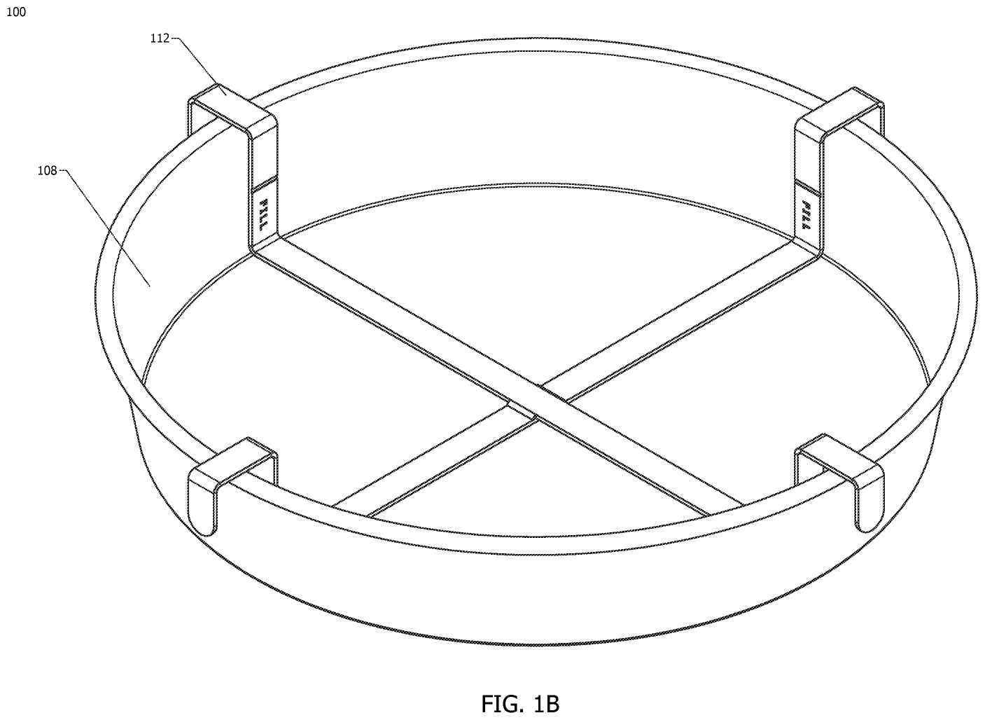

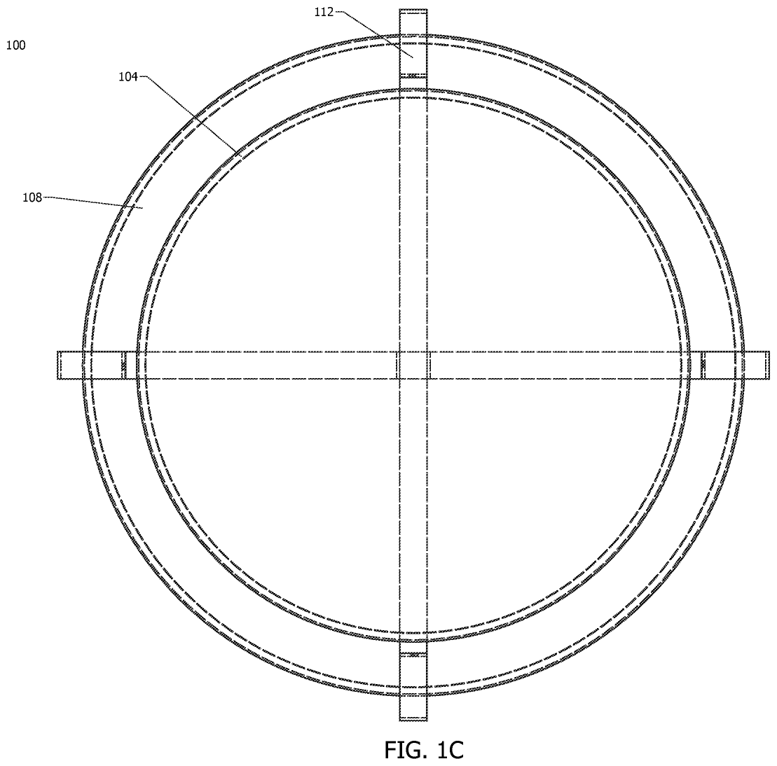

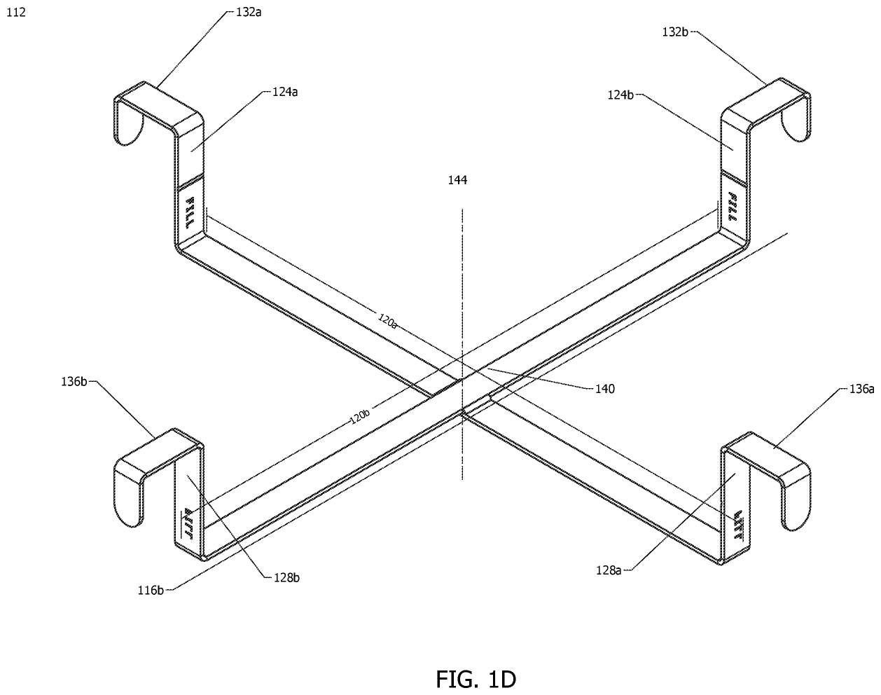

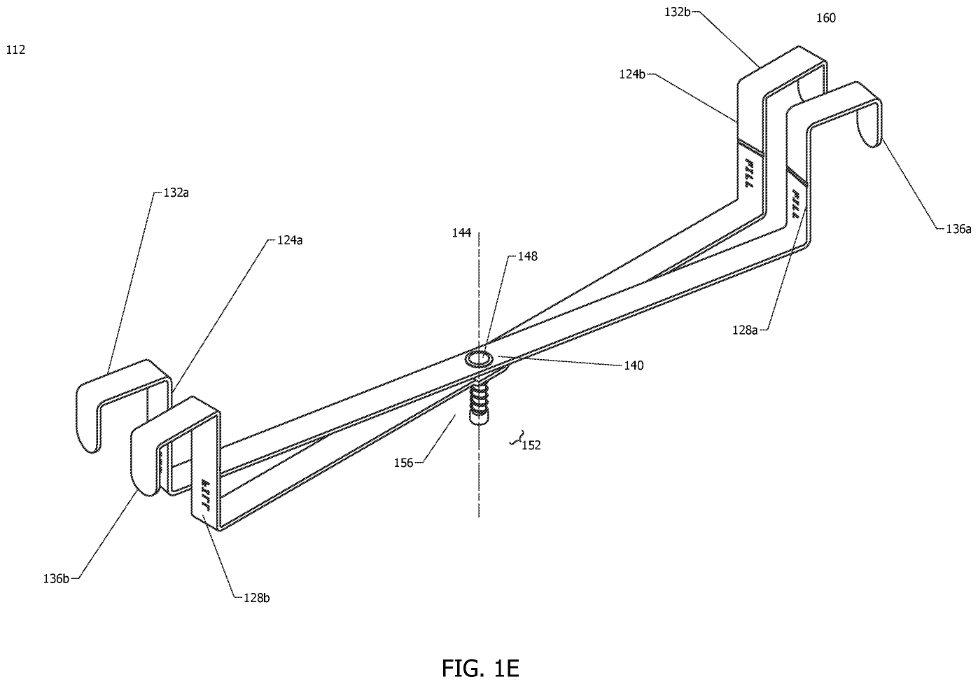

FIG. 1A illustrates a perspective view of the system 100 for baking, in accordance with one or more embodiments of the disclosure. The system 100 may be used for baking any type of food product including but not limited to cheesecake, crème brulee, or quiche, or any other type of food product that may necessitate a water bath.

In embodiments, the system 100 contains a first pan 104 configured for baking the food product. The first pan 104 may be configured as any type including but not limited to springform pans, push pans, pie pans, pie tins, or cake pans. The first pan 104 may be configured as any shape including but not limited to circular, square, or heart-shaped. The first pan 104 may be configured as any size or height including but not limited to a 9″×9″×3″ pan, a 10″×10″×3″, a 4″ pan, a 5″ pan, a 6″ pan, a 7″ pan, an 8″ pan, a 9″ pan, or a 10″ pan. The first pan 104 includes a first pan diameter 106.

In some embodiments, the system 100 further contains a second pan 108 configured as a water bath. The second pan 108 may be configured as any device that can be used for a water bath. For example, the second pan 108 may be configured as a bain-marie. In another example, the second pan 108 may be configured as a baking pan having larger dimensions (e.g., circumference and/or height) of that of the first pan 104. The second pan 108 may be configured with a different shape than of the first pan 104. For example, the first pan 104 may be configured as a circular pan, while the second pan 108 may be configured a square pan. The second pan 108 includes a second pan diameter 110. In general, the second pan 108 may be larger (e.g., one size larger) than the first pan 104.

In some embodiments, the system 100 contains a bracket 112 (e.g., mostly hidden from view in FIG. 1A) configured to suspend the first pan 104 within the second pan 108 (e.g., maintain the first pan within a suspended position within the second pan). For example, the second pan 108 may be partially filled with water, with the bracket 112 secured onto the second pan 108, and the first pan 104 secured on top of the bracket 112. In this configuration, the bottom portion of the first pan 104 may be securely immersed in the water with reduced risk of spilling the water from the water bath. The system 100 may be configured to include any or all components (e.g., first pan 104, the second pan 108, or the bracket 112). For example, the system 100 includes the first pan 104, the second pan 108, and the bracket 112. In another example, the system 100 includes only the bracket 112.

FIGS. 1B and 1C illustrate a perspective view and a plan view of the system 100 in various configurations, respectively, in accordance with one or more embodiments of the disclosure. FIG. 1B illustrates the placement of the bracket 112 onto the second pan 108. FIG. 1C further illustrates the placement of the first pan 104 onto the bracket 112.

FIG. 1D illustrates a perspective view of the bracket 112, in accordance with one or more embodiments of the disclosure. The bracket 112 may be made of any material including but not limited to metal, ceramic, glass, or plastic. For example, the bracket 112 may be made of stainless steel. The bracket 112 may be of any shape or size and may be configured to fit any shape or size of the first pan 104 and/or the second pan 108 as described herein.

In some embodiments, the bracket 112 includes two or more of a plurality of members 116a, 116b, which, when combined, provide a support surface for the first pan 104. The bracket 112 may contain two members 116a, 116b, and may contain any larger number of members 116a, 116b. For example, the bracket 112 may include six members 116a, 116b. In another example, the bracket 112 may include eight members 116a, 116b. The two or more members 116a, 116b may be permanently coupled (e.g., by welding, adhesives, or forging), movable (e.g., loosely coupled at the midsection of each member 116a, 116b), or removably coupled to each other (e.g., attached with a screw or clasps).

In some embodiments, the one or more of the plurality of members 116a, 116b includes a member span 120a, 120b. The member span 120a, 120b comprises a member length that is both longer than a first pan diameter 106 of the first pan 104 and shorter than a second pan diameter 110 of the second pan 108. One or more of the plurality of members 116a, 116b further includes a first raised portion 124a, 124b, coupled to one end (e.g., a first end) of the member span 120a, 120b and a second raised portion 128a, 128b coupled to the other end (e.g., a second end) of the member span 120a, 120b. When secured on the second pan 108, the first raised portion 124a, 124b and second raised portion 128a, 128b, controls the depth of the suspension of the first pan 104 within the second pan, and determines the maximum first pan diameter 106 that can be used.

It is contemplated, but not shown, that in some embodiments the first raised portion 124a, 124b and the second raised portion 128a, 128b may be adjustable to better accommodate second pans 108 of varying depth.

In some embodiments, the one or more of the plurality of members 116a, 116b includes a first coupling structure 132a, 132b coupled to the first raised portion 124a, 124b and a second coupling structure 136a, 136b coupled to the second raised portion 128a, 128b. The first coupling structure 132a, 132b and the second coupling structure 136a, 136b are configured to stabilize the bracket onto the second pan 108 by coupling to the rim of the second pan 108. For example, the first coupling structure 132a, 132b may be configured to couple to the rim of the second pan 108 in a first position, and the second coupling structure 136a, 136b may be configured to couple to the second pan in a second position approximately antipodal to the first position (e.g., the first coupling structure 132a, 132b and the second coupling structure 136a, 136b are coupled to opposite sides of the second pan 108).

The first coupling structure 132a, 132b and the second coupling structure 136a, 136b may be configured as any type of connecting/securing mechanism including but not limited to a hook, a clamp (e.g., a compression clamp or a screw clamp), an interference fit (e.g., press fit or friction fit), or a magnet. For example, the first coupling structure 132a, 132b and the second coupling structure 136a, 136b may be configured as a gooseneck-like structure that hooks onto the rim of the second pan 108.

In some embodiments, the bracket 112 further includes a connector 140 disposed on a midpoint of the member span 120a, 120b configured to couple two or more of the plurality of members 116a, 116b. The coupling of the two or more of the plurality of members 116a, 116b forms the bracket 112. The connector 140 may be configured as any type of connection technology including but not limited to an adhesive, a weld, a rivet, a screw, a nut and bolt, an interference fit, or a clamp.

FIG. 1E is a perspective view of the bracket 112, in accordance with one or more embodiments of the disclosure. In some embodiments, the connector 140 is configured to allow rotation of the two or more of the plurality of members 116a, 116b along a first axis 144 (e.g., the axis running perpendicular to the bottom surface of the first pan 104 relative to each other). The rotation allows the bracket 112 to be folded into a smaller stored configuration or to further adjust the bracket 112 to the second pan 108. For example, the connector 140 may be configured as a rivet 148 that couples the two or more of the plurality of members 116a, 116b while still allowing rotation. For instance, the connector 140 may include a rivet 148 that permits rotation and a spring-biasing element 152 coupled to the rivet 148 and biases a spring 156 against the two or more of the plurality of members 116a, 116b increasing friction against the two or more of the plurality of members 116a, 116b inhibiting rotation. The bracket 112 may also include offset/detent mechanism that inhibit rotation between the two or more of the plurality of members 116a, 116b. The connector 140 may also be configured to that the one or more members 116a-b are removable from each other. For example, the members 116a-b may be separated at the connection point for cleaning purposes.

In some embodiments, the rotation of the members 116a-b relative to each other along the first axis enables the bracket to fit to different sizes of second pans. For example, for a bracket 112 with two members 116a-b, the bracket 112 will fit a second pan 108 of a smallest circumference when the two members 116a-b are arranged perpendicular to each other (e.g., arrange like a plus sign “+”). By rotating the members 116a-b away from the perpendicular, the bracket 112 may fit a second pan 108 having a larger circumference.

In one or more embodiments, the connector may be configured to allow the members 116a, 116b to be removably couplable. For example, instead of a rivet 148, the connector 140 may be removable (e.g., a screw, nut and bolt, or the like). In this instance, the members 116a, 116b may be separated, which may allow for easier storage or cleaning of the bracket 112.

In some embodiments, the bracket 112 is spring-loaded. For example, the member span 120a, 120b may include a compression spring that allows the member span 120a, 120b to be compressed, shortening the member span 120a, 120b. For instance, the bracket 112 may be configured to fit inside a 10-inch second pan 108 with little or no compression from the compression springs, the member span 120a, 120b reaching across the second pan diameter 110 of the second pan 108. In another instance, the bracket 112 may be configured to fit inside the 10-inch second pan 108 with moderate compression from the compression springs. Once placed inside the second pan 108, the compression springs press the first raised portion 124a, 124b and second raised portion 128a, 128b against the inner circumference of the second pan 108, holding the bracket 112 in place. In another example, the bracket 112 may be configured to fit inside a 10-inch second pan 108 with little or no compression of the compression springs, and may be further compressed to fit inside an 8-inch second pan 108. In this manner, the bracket may be configured to fit multiple sizes of second pans 108, depending on the compression of the compression springs.

In some embodiments, the rotation of the member span 120a, 120b (e.g., one clockwise and one counter-clockwise) about the connector may allow for a better fit into certain second pan 108 shapes and/or sizes. For example, if the members 116a, 116b are rotated in a manner where the distance between the two components of the first coupling structure 132a, 132b and second coupling structure 136a, 136b decrease the bracket 112 will become elongated (e.g., first coupling structure 132a gets closer to second coupling structure 136b). This will help the bracket 112 fit into second pans 108 with a larger second pan diameter 110, while still providing a support for the first pan 104.

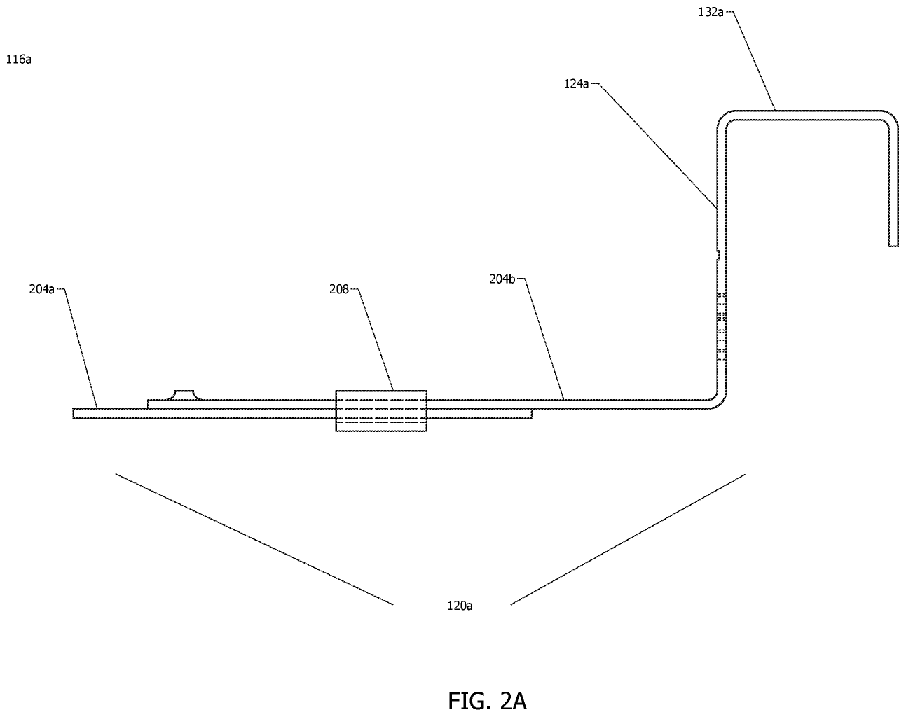

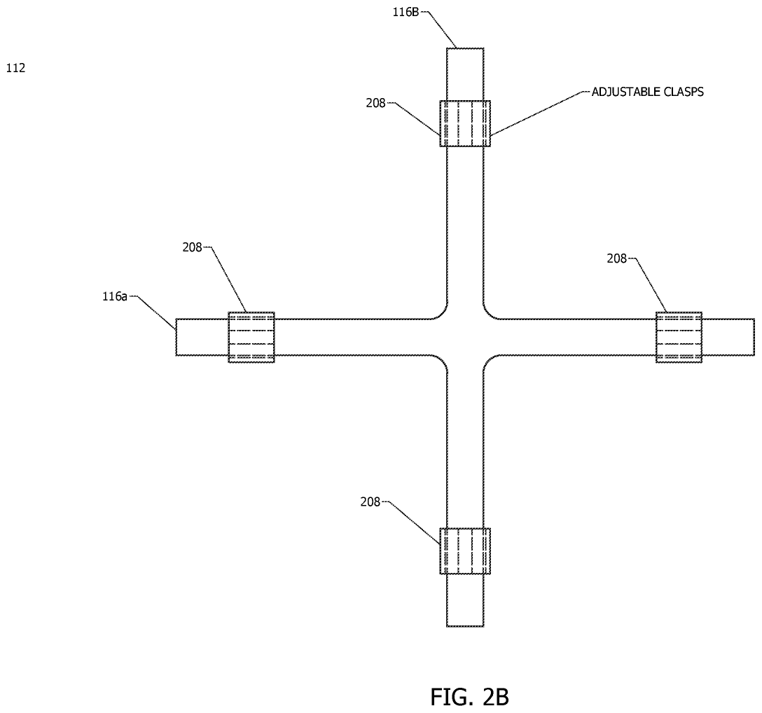

FIG. 2A illustrates a side view of a portion of the member 116a, having an adjustable member span 120a, in accordance with one or more embodiments of the disclosure. For example, the adjustable member span 120a may be bifurcated into two sub-spans 204a, 204b held in place by a clamp 208. The clamp 208 may then be released, allowing adjustment of the sub-spans 204a, 204b. The adjustment of the adjustable member span 120a via the sub-spans 204a, 204b and clamp 208 allow the member span to fit multiple sizes and shapes of second pans 108. A plan view of the bracket 112 with sub-spans 204a, 204b and clamps 208 is shown in FIG. 2B.

In some embodiments the member spans 120a, 120b may be comprised of two or more sub-spans 204a, 204b.

In some embodiments, the two or more sub-spans 204a, 204b may be fashioned in a way where they “telescope,” wherein one or more of the two sub-spans 204a, 204b are hollow and one sub-span has a smaller perimeter than the interior void of another sub-span, allowing one to fit within the other and slide out as necessary to fit larger second pans 108.

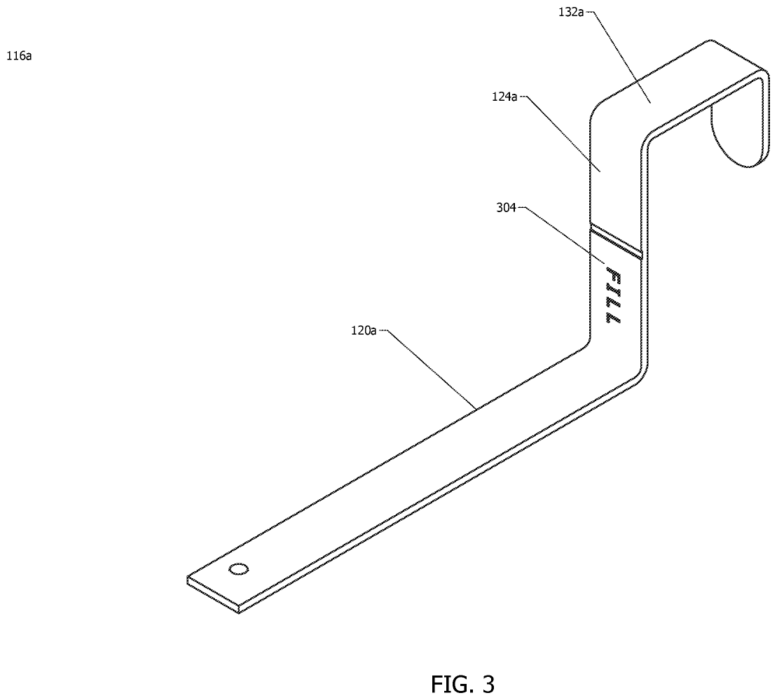

FIG. 3 illustrates a partial view of a member 116a, in accordance with one or more embodiments of the disclosure. In some embodiments, the first raised portion 124a, 124b and second raised portion 128a, 128b further contains one or more water level markings 304 to assist in determining the proper water level within the second pan 108. For example, if the water level in the second pan 108 is too low, wherein a water bath would be ineffective in providing the proper heating for the cheese cake, the water level markings 304 will indicate to the user to add water to the second pan 108. In some embodiments, the one or more water level markings 304 are configured so that the second pan 108 may be filled to the indicated water level first (e.g., via the one or more water level markings 304), before the first pan 104 is placed on top. For example, the one or more water level markings 304 may or may not anticipate the change in water level in the second pan 108 made by the displacement of water by the first pan 104.

In some embodiments, the one or more water level markings 304 may correspond to different water levels required to bake various food products. For example, the bracket 112 may have water level markings 304 for and type of food product that necessitate a water bath, including but not limited to cheesecake, crème brulee, or quiche, or any other type of food product that may necessitate a water bath.

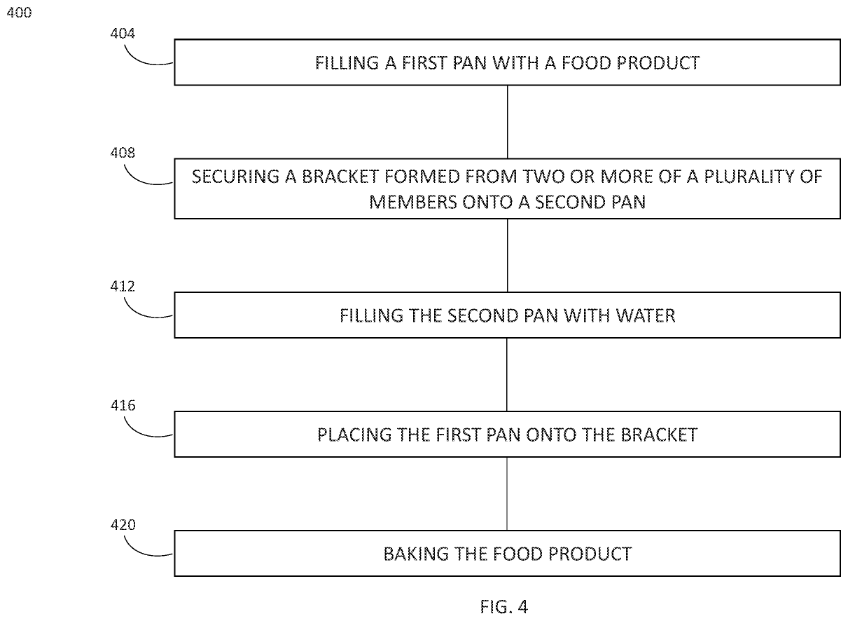

FIG. 4 is a flow chart illustrating a method 400 for baking a food product (e.g., cheesecake batter) via the bracket 112, in accordance with one or more embodiments of the disclosure. In one or more embodiments, the method 400 includes a step 404 of filling the first pan 104 with a food product. The food product may include any type of food as described herein.

In one or more embodiments, the method 400 further includes a step 408 of securing a bracket 112 formed from two or more of a plurality of members 116a, 116b onto the second pan 108. For example, the bracket 112 may be secured onto the rim of the second pan 108 via the first coupling structures 132a, 132b and the second coupling structures 136a, 136b.

In one or more embodiments, the method 400 further includes a step 412 of filling the second pan 108 with water. For example, water may be poured into the second pan 108 until the water reaches one of the one or more water level markings 304. In another example, the water may be poured into the second pan 108 before the first pan 104 is placed onto the bracket 112. For instance, the one or more water level markings 304 may be designed to not anticipate the displacement of water by the placement of the first pan 104 on the bracket 112, requiring the second pan 108 to be filled before placing the first pan 104 on the bracket.

In one or more embodiments, the method 400 further includes a step 416 of placing the first pan 104 onto the bracket 112. The first pan 104 is suspended within the second pan 108 and as the first pan 104 rests on the members 116a, 116b of the bracket 112 it may be further secured through contact with the first raised portion 124a, 124b and/or the second raised portion 128a, 128b. It may also be supported through contact with the first coupling structure 132a, 132b and/or the second coupling structure 136a, 136b

In one or more embodiments, step 412 may precede step 416. For example, the first pan 104 may be placed on the bracket 112 before step 416 of filling the second pan 108 with water (e.g., the placement of the first pan 104, second pan 108 and the bracket 112 are interchangeable in their order. For example, In another example, the one or more water level markings 304 may be designed to anticipate the displacement of water by the placement of the first pan 104 on the bracket 112. The placing the first pan 104 onto the bracket 112 may precede the filling the second pan 108 with the water. The placing of the first pan 104 onto the bracket 112 may also be subsequent to the filling the second pan 108 with the water.

In one or more embodiments, step 412 may be interchangeable with step 416. For example, the one or more water level markings 304 may both take into account the water displaced by the first pan 104, as well as not take into account the water displaced by the first pan 104.

In one or more embodiments, the method 400 further includes a step 420 of baking the food product. Here, the bracket 112 stabilizes the first pan 104 on top of the second pan 108, inhibiting unwanted movement of the first pan 104 and preventing sloshing of water which could spill onto the floor or into the first pan 104, ruining the food product to be cooked.

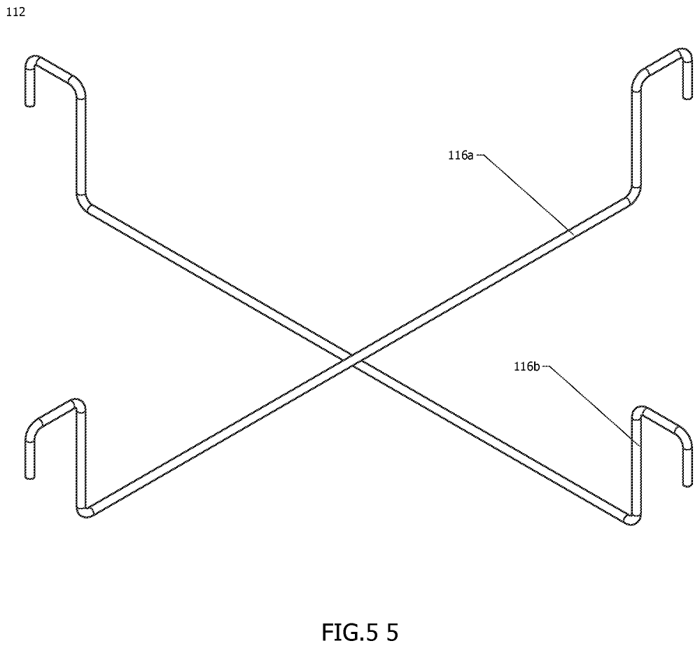

FIG. 5 illustrates a perspective view of bracket 112, in accordance with one or more embodiments of the disclosure. In one or more embodiments, the bracket 112 and the members 116a, 116b are not necessarily configured to be a flat rectangular shape. For example, the members 116a, 116b may be round rods, as shown in FIG. 5. In embodiments, different shapes may be used for the members 116a, 116b to use less material during manufacturing, while still providing a stable support surface for the first pan 104. For example, triangular members 116a, 116b may maximize contact between the first pan 104 and the water bath, while still providing a stable surface. In embodiments, the members 116a, 116b may be any shape, including but not limited to rectangular, circular, triangular, and the like.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

Although particular embodiments of this invention have been illustrated, it is apparent that various modifications and embodiments of the invention may be made by those skilled in the art without departing from the scope and spirit of the foregoing disclosure. It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Accordingly, the scope of the invention should be limited only by the claims appended hereto.

What is claimed:

1. A system for suspending a first pan within a second pan comprising:
a plurality of members, wherein two or more of the plurality of members comprise:
a member span comprising a member length, wherein the member length is configured to be longer than a first bottom diameter of the first pan and shorter than a second bottom diameter of the second pan;
a first raised portion coupled to a first end of the member span;
a second raised portion coupled to a second end of the first member span;
a first coupling structure attached to the first raised portion and configured to couple one or more members to a rim of the second pan in a first position; and
a second coupling structure attached to the second raised portion and configured to couple the one or more members to the rim of the second pan in second position approximately antipodal to the first position; and
a connector disposed on a midpoint of the member span, configured to couple two or more of the plurality of members, forming a bracket.

2. The system of claim 1, further comprising the first pan and the second pan, wherein the bracket is configured to maintain the first pan within a suspended position within the second pan.

3. The system of claim 2, wherein the bracket is configured to maintain the first pan within the suspended position within the second pan when the first pan and the second pan are configured to be various shapes and sizes.

4. The system of claim 1, wherein the first pan is configured for baking a food product.

5. The system of claim 4, wherein the food product is configured as a cheesecake.

6. The system of claim 4, wherein the second pan is configured as a water bath.

7. The system of claim 1, wherein the connector is configured as an adhesive.

8. The system of claim 1, wherein the connector is configured to allow rotation of the two or more of the plurality of members along a first axis relative to each other.

9. The system of claim 8, wherein the rotation enables the bracket to fit to different sizes of second pans based on relative positions of the plurality of members along the first axis.

10. The system of claim 1, wherein the connector allows the one or more members to be removably couplable to each other.

11. The system of claim 1, wherein the member span is adjustable to different member lengths.

12. The system of claim 1, further comprising one or more water level markings configured to indicate a level of water within the second pan.

13. The system of claim 12, wherein the one or more water level markings are configured for water baths of different food products.

14. A method comprising:
filling a first pan with a food product;
securing a bracket formed from two or more of a plurality of members onto a second pan;
placing the first pan onto the bracket;
filling the second pan with water; and
baking the food product.

15. The method of claim 14, wherein the placing the first pan onto the bracket and the filling the second pan with the water are one or more of the following: the placing the first pan onto the bracket and the filling the second pan with the water are interchangeable in their order; the placing the first pan onto the bracket precedes the filling the second pan with the water; or the placing the first pan onto the bracket is subsequent to the filling the second pan with the water.
